(19) United States
(12) Patent Application Publication
(10) Pub. No.: US 2006/0118144 A1
(43) Pub. Date: Jun. 8, 2006

(54) Self-cleaning filter of dishwasher, combining method of the same, and sump using the same

(76) Inventor: Sang Woo Woo, Changwon-si (KR)

Correspondence Address: MCKENNA LONG & ALDRIDGE LLP;Song K. Jung, 1900 K Street, N.W., Washington, DC, 20006, US

(21) Appl. No.: 11/295,673

(22) Filed: Dec. 7, 2005

(30) Foreign Application Priority Data
Dec. 7, 2004 (KR) 10-2004-0102553

(51) Int. Cl. B08B 3/00

(52) U.S. Cl. 134/56 D; 134/58 D

(57) ABSTRACT

A self-cleaning filter of a dishwasher, a combining method of the same, and a sump of a dishwasher using the self-cleaning filter are provided. The provided self-cleaning filter and the sump include an upper cover and a lower cover fused together, and a mesh filter disposed between the upper and lower covers.

### BACKGROUND OF THE INVENTION

1. Field of the Invention

The present invention relates to a dishwasher, and more particularly, to a self-cleaning filter of a dishwasher, a combining method of the same, and a dishwasher sump using the same.

2. Description of the Related Art

A dishwasher is a home appliance that sprays high-pressure wash liquid through spray nozzles to wash and remove food residue left on surfaces of dishes. Specifically, a dishwasher includes a tub forming a wash compartment, and a sump installed at the bottom of the tub for storing wash liquid. Installed inside the sump is a wash pump that pumps wash liquid to the spray nozzles. The wash liquid pumped to the spray nozzles is discharged under high pressure through spray holes at the ends of the nozzles. The high pressure wash liquid spray collides with the surfaces of dishes, so that food residue and other impurities on the dishes fall to the floor of the tub.

A filter resting at the top of the sump is a thin mesh forming many small holes. The filter is hot-melt adhered to a filter frame constituting an outer shape thereof. Here, because the filter is a thin mesh, when the temperature thereof drops after it is hot-melt adhered to the filter frame under high temperature, the filter can be deformed. In other words, when the temperature drops from a high to a low temperature, the filter expands and shrinks, during which its shape can be altered and creases can be formed. Accordingly, when the sump is completely assembled, the filter cannot retain a crease-free profile.

### SUMMARY OF THE INVENTION

Accordingly, the present invention is directed to a self-cleaning filter of a dishwasher that substantially obviates one or more problems due to limitations and disadvantages of the related art.

An object of the present invention is to provide a self-cleaning filter of a dishwasher with an improved combining structure capable of preventing deformation of a mesh due to temperature changes during a combining process of the filter, a combining method of the same, and a dishwasher sump using the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a self-cleaning filter of a self-cleaning filter of a dishwasher including: an upper cover; a lower cover melt-adhered to the upper cover; and a mesh filter disposed between the upper cover and the lower cover.

In another aspect of the present invention, there is provided a sump of a dishwasher including: a sump case for storing wash liquid supplied to a nozzle; a sump cover covering the sump case; a self-cleaning filter installed on the sump cover and including an upper cover, a lower cover melt-adhered to the upper cover, and a mesh filter disposed between the upper cover and the lower cover; and a lower spray arm holder for connecting a lower spray arm to the self-cleaning filter.

In a further another aspect of the present invention, there is provided a combining method for a self-cleaning filter of a dishwasher including: preparing an upper cover, a lower cover, and a mesh filter; placing the mesh filter between the lower cover and the upper cover; and melt adhering the lower cover and the upper cover.

A dishwasher employing the self-cleaning filter, the combining method thereof, and the dishwasher sump using the filter according to the present invention prevents deformation of a mesh caused by varying temperature during its hot-melt adhesion process. That is, after completion of filter assembly, the mesh will retain a crease-free disposition, to provide a clean outward appearance.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a dishwasher according to the present invention;

FIG. 2 is a perspective view of a sump according to the present invention;

FIG. 3 is a sectional view of the sump in FIG. 2 taken along line I-I′;

FIG. 4 is an exploded perspective view of a sump according to the present invention;

FIG. 5 is a perspective view of a lower spray arm holder that is installed at the central top portion of the sump, according to the present invention;

FIG. 6 is a perspective view of a self-cleaning filter according to the present invention;

FIG. 7 is a perspective view of a sump with the self-cleaning filter removed, according to an embodiment of the present invention;

FIG. 8 is a perspective view of an upper cover used in the self-cleaning filter according to the present invention;

FIG. 9 is a perspective view of a mesh filter used in the self-cleaning filter according to the present invention; and

FIG. 10 is a perspective view of a lower cover used in the self-cleaning filter according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

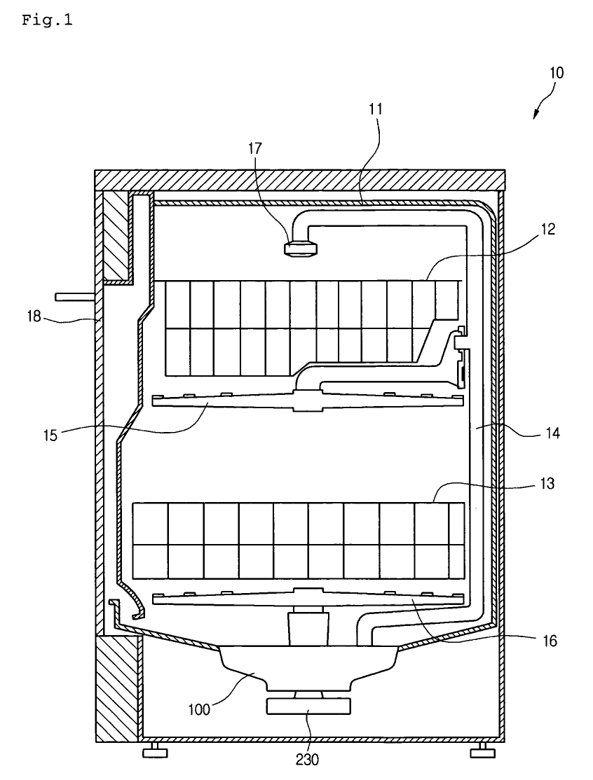

FIG. 1 is a sectional view of a dishwasher according to the present invention.

Referring to FIG. 1, a dishwasher 10 according to the present invention includes a tub 11 forming the outer shape of the dishwasher 10 and a wash compartment within, a door 18 formed at the front of the tub 11 for opening and closing the wash compartment, and a sump 100 formed at a central bottom portion of the tub 11 for storing wash liquid.

Additionally, the dishwasher 10 includes a wash motor 230 attached to the bottom end thereof for driving a wash pump (not shown) disposed inside the sump 100, a water guide 14 providing a passage for wash liquid pumped by the wash pump, a lower spray arm 16 coupled to the top of the sump 100 for spraying wash liquid within the wash compartment in an upward and/or downward direction, an upper spray arm 15 attached at an upper portion of the water guide 14 to extend horizontally therefrom to be centrally disposed inside the wash compartment, and a top nozzle 17 formed at the ceiling of the tub 101 to spray wash liquid in a downward direction.

Additionally, the dishwasher 10 includes an upper rack 12 installed above the upper spray arm 15 to wash dishes with the upper spray arm 15, and a lower rack 13 installed above the lower spray arm 16 to wash dishes with the lower spray arm 16.

The operation of the above dishwasher 10 according to the present invention will now be described.

First, a user opens the door 18 of the dishwasher 10, pulls the upper and/or lower racks 12 and 13 out, and places dishes in the upper rack 12 and/or the lower rack 13. The door 18 is then closed, power is turned on, and the dishwasher 10 is activated.

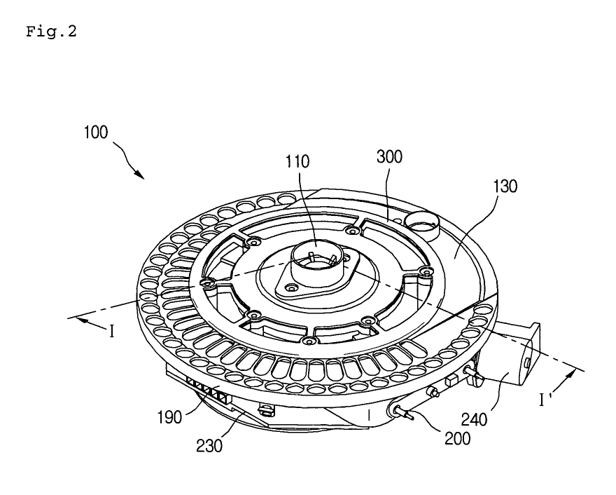

When power to the dishwasher 10 is turned on and a wash cycle is instigated, wash liquid enters the sump 100 from a water supply. After a predetermined amount of wash liquid enters the sump 100, the wash motor 230 operates. An impeller (150 in FIG. 2), connected to a shaft of the wash motor 230 and disposed inside the wash pump, rotates to pump wash liquid to the lower spray arm 16 and the water guide 14.

The wash liquid pumped to the water guide 14 ultimately flows to the top nozzle 17 and the upper spray arm 15 to be sprayed therefrom into the wash compartment. The sprayed wash water washes dishes placed in the racks 12 and 13.

Here, the top nozzle 17 sprays wash liquid in a vertically downward direction and the upper spray arm 15 sprays wash liquid in a vertically upward direction to wash dishes placed in the upper rack 12.

The lower spray arm 16 sprays wash liquid in a vertically upward direction to wash dishes placed in the lower rack 13. Additionally, the upper spray arm 15 may have spray holes also formed at the bottom thereof to spray wash liquid in both upward and downward directions, to wash the tops of dishes placed in the lower rack 13 at the same time.

When the wash cycle is completed, the dirty wash liquid collected in the sump 100 is removed of impurities by means of a filter (not shown). A wash liquid drain pump (not shown) dispels the filtered wash liquid to the outside of the dishwasher 10.

After the wash liquid is dispelled to the outside, fresh wash liquid enters the sump 100 through an inlet, whereupon the wash liquid is sprayed through the spray arms 15 and 16 in the same manner as in the wash cycle. The clean, sprayed wash liquid rinses the dishes in a rinse cycle. When the rinse cycle is completed, a drying cycle is implemented to complete the dishwashing process.

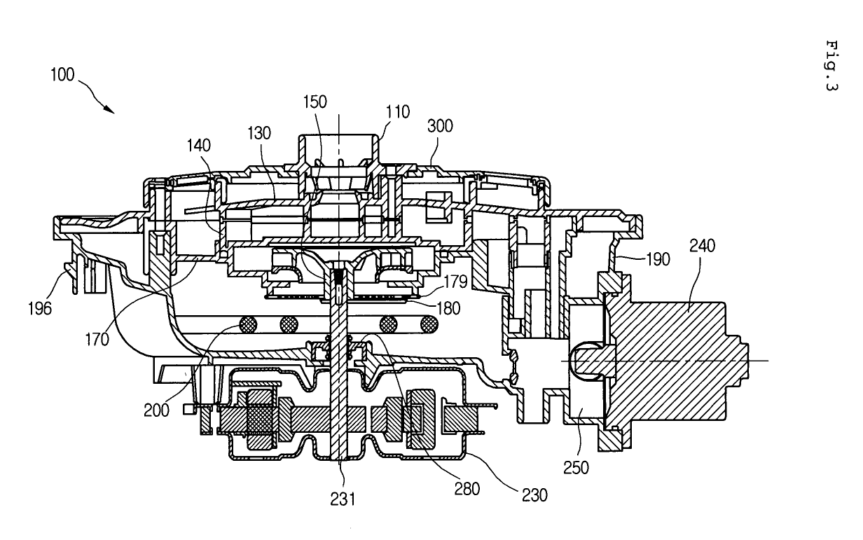

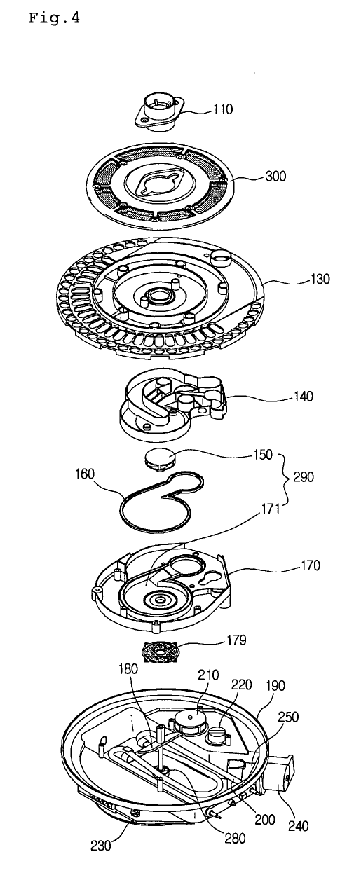

FIG. 2 is a perspective view of a sump according to the present invention, FIG. 3 is a sectional view of the sump in FIG. 2 taken along line I-I′, and FIG. 4 is an exploded perspective view of a sump according to the present invention.

Referring to FIGS. 2 through 4, the sump 100 according to the present invention includes: a sump case 190 disposed at a lowermost end thereof for storing wash liquid, a sump cover 130 that covers the upper surface of the sump case 190, a self-cleaning filter 300 stepped a predetermined height from and mounted on the top surface of the sump cover 130, a lower spray arm holder 110 mounted on the central portion of the self-cleaning filter 300 and connected to the lower spray arm 16, a wash motor 230 installed at the bottom of the sump case 190 for imparting rotational force, and a drain pump 250 and a drain motor 240 installed on a side of the sump case 190 for draining wash liquid to the outside.

The sump 100 further includes: a heater 200 installed at the inner floor of the sump case 190 for heating wash liquid, a disposer 180 connected to the motor shaft 231 of the wash motor 230 to rotate integrally with the motor shaft 231 and pulverize food residue, a pump lower unit 170 mounted to the upper surface of the sump case 190 and including a soil chamber for collecting food residue, a guide passage 140 mounted between the sump cover 130 and the pump lower unit 170, a wash pump 290 formed between the sump lower unit 170 and the guide passage 140 for pumping wash liquid, and a screen filter 179 installed between the pump lower unit 170 and the disposer 180 for preventing food residue pulverized by the disposer 180 from entering the wash pump 290.

In further detail, the screen filter 179, being a filter with a plurality of small holes formed therein for filtering food residue, is attached to the bottom of the sump lower unit 170. The wash pump 290 is mounted in the central portion of the pump lower unit 170, and includes an impeller 150 that is connected to and rotates integrally with the motor shaft 231 and a pump case 171 in which rising wash liquid swirls by means of the impeller 150. Additionally, a passage is formed at the upper surface of the guide passage 140 for guiding wash liquid pumped by the wash pump 290 to the water guide or lower spray arm. The passage will now be described with reference to the diagrams.

In addition, the sump 100 is installed at a side of the sump case 190, and includes a vario valve 210 that intermittently allocates wash liquid pumped by the wash pump 290 to the upper and lower spray arms, and a turbidity sensor 220 installed proximally to the vario valve 210 for sensing the turbidity of wash liquid collecting in the sump 100 during a wash cycle. Furthermore, a pump gasket 160 is inserted in a recess formed at the upper portion of the pump lower unit 170, in order to prevent wash liquid from leaking from the perimeters of the wash pump 290 and the vario valve 210.

The operation of the sump 100 with the above-described structure will now be set forth.

First, when a wash cycle begins, wash liquid flows into the sump case 190 from a water supply device, and the wash motor 230 operates to rotate the impeller 150. When the impeller 150 rotates, wash liquid enters the pump case 171, and the wash liquid that enters the pump case 171 flows toward the vario valve 210. The wash liquid that moves to the vario valve 210 flows along the passage on the upper surface of the guide passage 140 to the water guide 14 or the lower spray arm holder 110. The wash liquid that moves to the water guide 14 or the lower spray arm holder 110 is sprayed into the tub by the upper spray arm 15 and the top nozzle 17 or the lower spray arm 16. The food residue on dishes is washed and removed by the sprayed wash liquid. The wash liquid sprayed inside the tub falls to the bottom of the tub 11. The wash liquid that falls down returns to be stored inside of the sump case 190.

A portion of the wash liquid moving from the wash pump 290 to the vario valve 210 is allotted toward the turbidity sensor 220. The wash liquid that passes the turbidity sensor 220 to be measured for turbidity then moves to the drain pump 250, and the wash liquid that moves to the drain pump 250 is dispelled to the outside of the dishwasher by means of the drain motor 240.

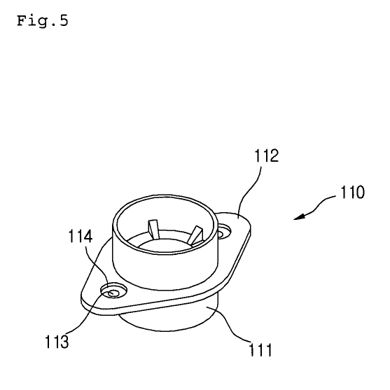

FIG. 5 is a perspective view of a lower spray arm holder that is installed at the central top portion of the sump, according to the present invention.

Referring to FIG. 5, the lower spray arm holder 110 has a cylindrical holder body 111 formed with a predetermined diameter and height, and a flange 112 formed to extend a predetermined distance radially outward from the outer surface of the holder body 111 for mounting to the upper surface of the sump cover 300.

In further detail, the flange 112 includes a fastening hole 113 on at least one side thereof for passing a fastening member that fastens the lower spray arm holder 110 to the sump cover 300 through the fastening hole 113, and a recessed portion 114 with a predetermined depth and diameter formed around the periphery of the fastening hole 113. Accordingly, when the fastening member is fastened, the head of the fastening member does not protrude above the flange 112.

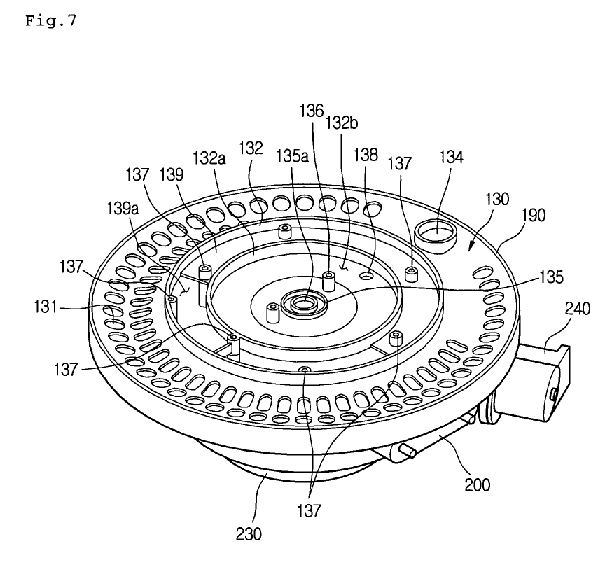

Additionally, the holder body 111 extends downward from the flange 112 to contact the central portion of the sump cover 130. In other words, the wash liquid discharge hole (135a in FIG. 7) formed in the central portion of the sump cover 130 is directly connected to the holder body 111, so that wash liquid does not leak out and flows directly to the lower nozzle.

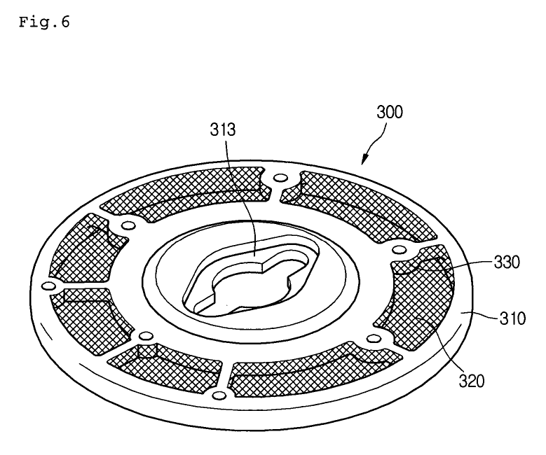

FIG. 6 is a perspective view of a self-cleaning filter according to the present invention.

Referring to FIG. 6, a self-cleaning filter 300 according to the present invention includes an upper cover 310 forming the outer shape thereof, a lower cover 330 installed at the bottom of the upper cover 310 and hot-melt or vibration-melt adhered to the upper cover 310, and a mesh filter 320 interposed between the upper and lower covers 310 and 330 and having a plurality of small holes formed therein.

In further detail, the mesh filter 320 retains a crease-free disposition due to it being pressed between the upper and lower covers 310 and 330. At the approximate central portion of the upper cover 310 is a recessed lower spray arm holder mounting portion 313 for mounting the lower spray arm holder 110. A detailed description of the self-cleaning filter 300 will now be set forth, with reference to the diagrams.

FIG. 7 is a perspective view of a sump with the self-cleaning filter removed, according to an embodiment of the present invention.

Referring to FIG. 7, the self-cleaning filter 300 according to the present invention is mounted to the top portion of the sump cover 130.

Specifically, the sump cover 130 is mounted to the upper portion of the sump case 190, and has a plurality of return holes 131 of a predetermined size formed at the outer periphery thereof for returning the wash liquid to the sump case 190.

In further detail, the sump cover 130 includes a filter support sleeve 132 (formed to protrude a predetermined distance upward from along a perimeter that is radially inward to the return holes 131) for mounting the self-cleaning filter on, and a leakage collecting sleeve 132a spaced a predetermined distance radially inward from the filter support sleeve 132 and forming a perimeter protruding a predetermined distance upward. Leaked wash liquid is stored within the wall of the leakage collecting sleeve 132a that forms a leakage collecting chamber 132b. Because the filter support sleeve 132 is formed at a predetermined height, the mesh filter 320 of the self-cleaning filter 300 is spaced a predetermined height from the sump cover 130. Resultantly, the mesh filter 320 is not immersed in wash liquid that collects in the tub. Thus, the wash liquid sprayed downward from the lower spray arm 16 attached to the top of the self-cleaning filter 300 is directly sprayed onto the mesh filter 320 to effectively disperse food residue attached to the mesh filter 320.

Also, the sump cover 130 includes a lower spray arm holder support rib 135 coupled to the holder body 111 at the central portion of the lower spray arm holder 110, and a wash liquid discharge hole 135a formed with a predetermined diameter within the lower spray arm support rib 135. Inside the leakage collecting chamber 132, at least one lower spray arm holder fixing boss 136 for coupling the lower spray arm holder 110 is provided. A drain hole 138 is further provided near the periphery of the leakage collecting chamber 132b for allowing wash liquid collected in the leakage collecting chamber 132b to fall into the sump case 190.

Also, a wash liquid reverse flow hole 139a (for reversing the flow of wash liquid pumped by the drain pump 250 through the self-cleaning filter 300 into the tub) forms one portion between the filter support sleeve 132 and the leakage collecting sleeve 132a, and an impurity collecting member 139 (for collecting a portion of the wash liquid that passes through the wash liquid reverse flow hole 139a) forms the other portion between the filter support sleeve 132 and the leakage collecting sleeve 132a. Also formed is at least one self-cleaning filter fixing boss 137 for fixing the inner surface of the filter support sleeve 132 and the outer surface of the leakage collecting sleeve 132a to the self-cleaning filter 300 to protrude a predetermined height from the impurity collecting member 139. At one end of the periphery of the sump cover 130 is a cylindrically-formed water guide connecting portion 134 for connecting to the lower portion of the water guide 14.

In the above-structured sump cover 130, the wash liquid falling into the sump case 190 enters the inside of the sump case 190 through return holes 131. The wash liquid flowing from the drain pump 250 reverse-flows through the wash liquid reverse-flow hole 139a to the floor of the sump case 190, and then re-enters the sump case 190 through the return holes 131. The wash liquid pumped by the wash pump 290 flows to the lower spray arm 16 or the water guide 14 through the wash liquid discharge hole 135a or the water guide connecting portion 134.

Additionally, during the flowing of wash liquid to the lower spray arm 16, wash liquid that leaks through the gap between the lower spray arm holder support rib 135 and the holder body 111 of the lower spray arm holder 110 is collected by the leakage collecting chamber 132b. The collected wash liquid enters the sump case 190 through the drain hole 138.

Furthermore, a portion of the reverse-flowing wash liquid flowing through the wash liquid reverse-flow hole 139a collects on the impurity collecting member 139, and moves through the wash liquid reverse-flow hole 139a to the drain pump 250 when the draining process is begun.

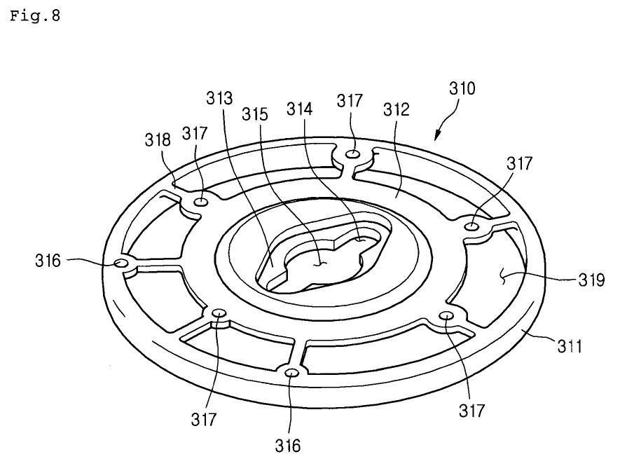

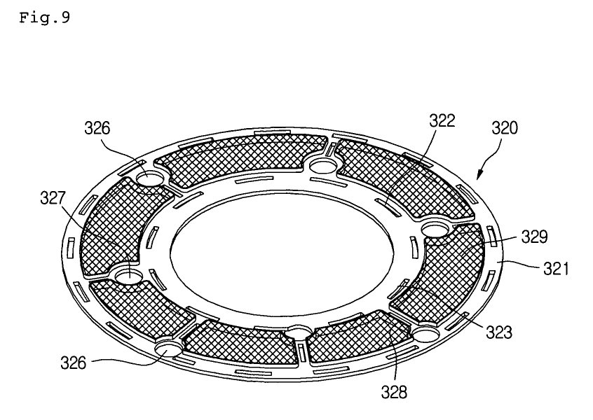

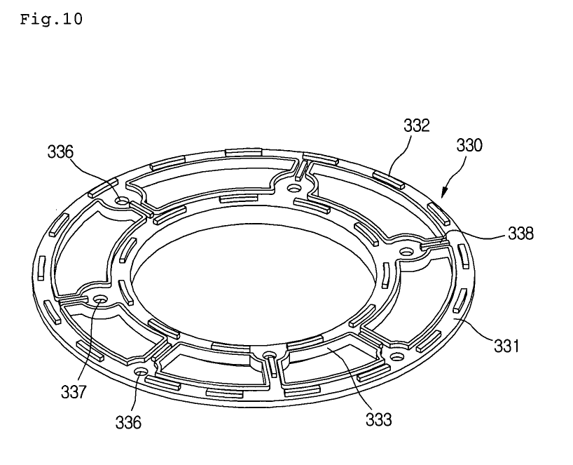

FIGS. 8 through 10 are perspective views of components of the self-cleaning filter according to the present invention. FIG. 8 is a perspective view of an upper cover used in the self-cleaning filter according to the present invention, FIG. 9 is a perspective view of a mesh filter used in the self-cleaning filter according to the present invention, and FIG. 10 is a perspective view of a lower cover used in the self-cleaning filter according to the present invention.

Referring to FIGS. 8 through 10, the self-cleaning filter 300 according to the present invention, as described above, includes an upper cover 310 forming the upper outer shape thereof, a mesh filter 320 disposed at the bottom surface of the upper cover 310 for filtering impurities, and a lower cover 330 disposed at the bottom surface of the mesh filter 320 for maintaining the mesh filter 320 in a crease-free state. The upper and lower covers 310 and 330 are integrally assembled using hot-melt or vibration adhesion techniques.

In more detail, the upper cover 310 includes a frame 311 forming its outer shape, a leakage collecting chamber cover 312 formed within the frame 311 for covering the upper surface of the leakage collecting chamber 132b of the sump cover 130, a lower spray arm holder mounting portion 313 formed recessively in the central portion of the leakage collecting chamber cover 312 for receiving the flange 112 of the lower spray arm holder 110, and a holder body through-hole 315 and a recessed portion insert hole 314 formed through the inner surface of the lower spray arm holder mounting portion 313 for inserting the holder body 111 and the recessed portion 114 of the lower spray arm holder 110.

Further provided are a frame bridge 318 connecting the frame 311 and the leakage collecting chamber cover 312, a sump case fastening hole 316 formed in the frame bridge 318 for inserting a fixing member that couples the sump cover 130 with the sump case 190, and a sump cover fastening hole 317 for inserting a fixing member that couples the self-cleaning filter 300 to the sump cover 130. Specifically, a mesh hole 319 formed between the frame 311 and the leakage collecting chamber cover 312 is partitioned by the frame bridge 318 into a predetermined size. Also, the mesh (328 in FIG. 9) of the mesh filter 320 is disposed within the mesh hole 319.

The frame 311 of the upper cover 310 forms ribs extending a predetermined distance downward, and the mounting of the self-cleaning filter 300 on the filter support sleeve 132 of the sump cover 130 to be spaced a predetermined height above the upper surface of the sump cover 130 is the same as described above.

Also, the mesh filter 320 is installed at the bottom of the upper cover 310, the outer frame is attached to the lower end of the frame 311 of the upper cover 310, the inner frame 323 is attached to the bottom of the outer periphery of the leakage collecting cover, a sump case fastening hole 326 and a sump cover fastening hole 327 communicate with the frame bridge 328 (attached to the bottom of the frame bridge 318) and the sump case fastening hole 316, and a mesh 329 installed between the inner and outer frames 323 and 321. Here, the mesh 329 is partitioned by the frame bridge 328, and is flattened during the hot melt adhering process of the frame bridge 328 between the frame bridge of the upper cover 310 with the frame bridge 338 of the lower cover 330.

Also, formed in the outer frame 321, the inner frame 323, and the frame bridge 328 is at least one melt adhering rib through-hole 322 for inserting the melt adhering rib (332 in FIG. 10) formed on the lower cover 330.

Furthermore, the lower frame 330 includes an outer frame 331 attached to the bottom of the outer frame 321 of the mesh filter 320, an inner frame 333 attached to the bottom of the inner frame 323, a frame bridge 338 attached to the bottom of the frame bridge 328, and a sump case fastening hole 336 and a sump cover fastening hole 337 communicating with the sump case fastening hole 326 and the sump cover fastening hole 327. Also, at least one melt adhering rib 332 is formed on the inner frame 333, the outer frame 331, and the frame bridge 338.

In further detail, the melt adhering rib 332 passes through the melt adhering rib through-hole 332 and is hot-melt or ultrasound-melt adhered to the bottom of the upper cover 310. Because the upper cover 310 and the lower cover 330 are firmly melt-adhered by means of hot-melt of vibration-melt adhering, the mesh 329 is flattened and does not crease when the temperature of the self-cleaning filter 300 cools after the melt adhering process.

That is, the melt adhering rib 332 is melt-adhered to the upper cover 310, so that the self-cleaning filter 300 is assembled with the lower cover 330 pressed firmly against the upper cover 310. Here, the mesh filter 320 is fixed according to the adhering force provided by the melt adhering rib 332 inserted through the melt adhering rib through-hole 332. Accordingly, because the mesh filter 320 is not directly melt-adhered to the upper and lower covers 310 and 330, there is virtually no deformation of the mesh filter 320 when temperature drops after the self-cleaning filter 300 is combined.

A combining method of the self-cleaning filter of a dishwasher according to the present invention will now be described.

First, the upper cover 310, the lower cover 330, and the mesh filter 320 are prepared.

Next, the mesh filter 320 is placed between the lower cover 330 and the upper cover 310. Specifically, the mesh filter 320 is seated on top of the lower cover 330. Then, the melt adhering rib 332 is inserted through the melt adhering rib through-hole 322. The melt adhering rib 332 is provided in plurality, and the coupling of the melt adhering rib 332 with the melt adhering rib through-hole 322 fixes the mesh filter 320 on top of the lower cover 330. Also, the frame bridges 328 and 338, the outer frames 321 and 333, and the inner frames 323 and 333 are mutually coupled to securely fix the mesh filter 320 over the lower cover 330. Next, the upper cover 310 is seated on top of the assembly consisting of the lower cover 330 and the mesh filter 320.

Subsequently, the lower cover 330 and the upper cover 310 are melt-adhered. Specifically, melt adhering is focused between the melt adhering rib 332 and area of the lower portion of the upper cover 310 contacting the melt adhering rib 332. Here, hot-melt or ultrasound-melt adhering may be used. When the melt adhering is thus performed, the melt adhering rib 332 and the lower portion of the upper cover 310 are firmly coupled. Accordingly, the lower cover 330 and the upper cover 310 are firmly coupled, and the mesh filter is installed therebetween. Here, the mesh filter 320 is not directly melt-adhered to the lower and upper covers 330 and 310, and may not receive a large amount of heat during the melt adhering process. Therefore, when the melt adhering is completed and cooling occurs, the mesh filter 320 and especially the mesh 329 undergoes virtually no deformation and retains its shape.

The self-cleaning filter of a dishwasher according to the present invention, its combining method, and a dishwasher sump using the filter prevents deformation of the filter caused by temperature fluctuation during the melt adhering process. That is, after the assembly of the filter is completed, the mesh retains a crease-free state for an outwardly clean appearance.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A self-cleaning filter of a dishwasher, comprising:
an upper cover;
a lower cover melt-adhered to the upper cover; and
a mesh filter disposed between the upper cover and the lower cover.

2. The self-cleaning filter according to claim 1, further comprising a melt adhering rib protruding from at least one of the upper cover and the lower cover for melt adhering and coupling the upper cover and the lower cover.

3. The self-cleaning filter according to claim 2, wherein the melt adhering rib is formed on the lower cover.

4. The self-cleaning filter according to claim 2, wherein the melt adhering rib melt-adheres to a cover from the upper cover and the lower cover that is opposite to the melt adhering rib.

5. The self-cleaning filter according to claim 2, wherein the melt adhering rib is formed in plurality.

6. The self-cleaning filter according to claim 2, wherein the mesh filter includes a hole through which the melt adhering rib inserts.

7. The self-cleaning filter according to claim 1, wherein the melt adhering of the lower cover to the upper cover is a hot-melt adhering or an ultrasound-melt adhering.

8. A sump of a dishwasher comprising:
a sump case for storing wash liquid supplied to a nozzle;
a sump cover covering the sump case;
a self-cleaning filter installed on the sump cover and including an upper cover, a lower cover melt-adhered to the upper cover, and a mesh filter disposed between the upper cover and the lower cover; and
a lower spray arm holder for connecting a lower spray arm to the self-cleaning filter.

9. The sump according to claim 8, wherein the self-cleaning filter is installed on the sump cover through a fastening member.

10. The sump according to claim 8, further comprising a melt adhering rib protruding from at least one of the upper cover and the lower cover for melt adhering and coupling the upper cover and the lower cover.

11. The sump according to claim 10, wherein the melt adhering rib is formed on the lower cover.

12. The sump according to claim 10, wherein the melt adhering rib melt-adheres to a cover from the upper cover and the lower cover that is opposite to the melt adhering rib.

13. The sump according to claim 10, wherein the melt adhering rib is formed in plurality.

14. The sump according to claim 10, wherein the mesh filter includes a hole through which the melt adhering rib inserts.

15. The sump according to claim 8, wherein the melt adhering of the lower cover to the upper cover is a hot-melt adhering or an ultrasound-melt adhering.

16. A combining method for a self-cleaning filter of a dishwasher comprising:
preparing an upper cover, a lower cover, and a mesh filter;
placing the mesh filter between the lower cover and the upper cover; and
melt adhering the lower cover and the upper cover.

17. The combining method according to claim 16, wherein the preparing of the upper and lower covers and the mesh filter includes forming a melt adhering rib on at least one of the upper cover and the lower cover for melt adhering.

18. The combining method according to claim 17, wherein the preparing of the upper and lower covers and the mesh filter further includes forming a hole through which the melt adhering rib inserts, and the placing of the mesh filter between the lower cover and the upper cover includes inserting the melt adhering rib through the hole.

19. The combining method according to claim 17, wherein the melt adhering of the lower cover and the upper cover includes melt adhering the melt adhering rib to a cover from the upper cover and the lower cover that is opposite to the melt adhering rib.

20. The combining method according to claim 16, wherein the melt-adhering of the lower cover and the upper cover is a hot-melt adhering or an ultrasound-melt adhering.
